(19) United States
(12) Patent Application Publication
(10) Pub. No.: US 2009/0080528 A1
(43) Pub. Date: Mar. 26, 2009

(54) Video codec method with high performance

(75) Inventors: Wen-Tsong Shiue, Taipei (TW); Ren-Jie Hsieh, Taipei (TW)

Correspondence Address: BACON & THOMAS, PLLC, 625 SLATERS LANE, FOURTH FLOOR, ALEXANDRIA, VA, 22314-1176, US

(73) Assignee: Alvaview Technology Inc., Taipei City (TW)

(21) Appl. No.: 11/902,225

(22) Filed: Sep. 20, 2007

(51) Int. Cl. H04N 11/04

(52) U.S. Cl. 375/240.16; 375/E07.105

(57) ABSTRACT

The present invention relates to a video codec method with high performance comprising the following steps: 1. predicting the motion vectors in the blocks to be predicted through Median Prediction and Up-layer Prediction, 2. terminate the motion prediction in the blocks predicted once the predicted motion vectors are below a threshold value. Otherwise, 3. Sample data in the block to be predicted and then, based on the data sampled, determine a block best resembling the above block from which samples are sampled for a further OTA search to finish a block motion prediction. By such steps, the overall amount of video encoding processing is dramatically reduced and performance is improved without sacrificing video quality. In addition, we may make a more accurate motion prediction of the block to be predicted to avoid the wrong prediction that an OTA algorithm might result in when the motion vector is exceedingly large.

### BACKGROUND OF THE INVENTION

1. Field of the Invention

The present invention relates to a video codec method, particularly it pertains to a video codec method with high performance.

2. Description of the Related Art

The Internet is one of the greatest inventions of human beings in the twentieth century. It has changed the world, which is getting smaller and smaller, and is becoming borderless. At the time the Internet is changing our world, human beings are also changing the Internet. The Internet has entered into a brand new era comparing with what it was ten years ago. It is highly developed, with online shopping, audio-video contents, video on demand, commercials, and search engines. For each developing stages, technology always played the leading part in terms of basic characteristics.

The most crucial impact that the Internet has brought to us is our rediscovery of broadcasting notion, which is not only the success of new technology, but also a revolution of broadcasting notion. Meanwhile, the combination of the Internet and video has further brought the Internet into our daily life. What it has brought to us is not only low cost and the free contents, but also the unconceivable convenience.

H.264/AVC is the latest standard that was established by ITU-T and MPEG organization for the new generation of video compression, which has better compression performance comparing with H.263 and MPEG-4 Simple Profile. Under the same reconstructed image quality, H.264 has less bit rate (encoding rate) than H.263 does by approximately 50%. Owing to this even higher compression ratio, better IP and wireless channel adaptability, it has been widely used in the fields of digital video communication and storage.

The advantages of H.264 are as follows:
1. Less bit rate by as much as 50%: With the same encoder, under the same optimization conditions, H.264 may save bit rate by as much as 50% comparing with H.263v2 (H.263+) or MPEG-4.
2. High quality video: Either in high or low bit rate, H.264 offers stable and consistently good video quality.
3. Error Resilience: H.264 is equipped with various essential tools, which may manage not only packet loss over the net but also the possible bitwise errors on an error-prone wireless network.
4. Network compatibility: H.264 produces data stream in packets, which may be transferred in Network Adaptation Layer. Consequently, H.264 data stream may easily travel in a collection of heterogeneous networks. These advantages allow H.264 to be an ideal standard for many applications, for example, videoconference and broadcasting video.

To implement H.264 algorithm, we usually use Median Prediction to predicate the Motion Vectors in adjacent blocks in advance. The reference block is located by reference to its left, upper, upper-right, and upper-left blocks, as shown in Median Prediction reference block illustration in FIG. 1, in which the block is the motion vector block to be predicted, A, B, C, and D are the reference blocks on which prediction is made. As shown in FIG. 2, it is an illustration of Median Prediction motion vector, which is shown as follows:

$$PMv \vec{E} = median ( Mv \vec{A} , Mv \vec{B} , Mv \vec{C} , Mv \vec{D} )$$

H.264 comprises seven types of Block Motion Searches, as shown in FIG. 3, in which the Up-layer Prediction is made by using the motion vectors in each blocks, based on these motion vectors, to reach an effective motion vector prediction. As shown in FIG. 4, it is an Up-layer motion vector illustration.

In addition, among all current block motion prediction algorithms, OTA (Once at a Time Algorithm) is the most easy and intuitive one. The other algorithms are TSS, TDL, BSS, FSS, OSA, CSA, OTA, and SS.

The first thing of the key concept of OTA is to locate the blocks with minimum differences by conducting horizontal searches on the blocks to be predicted, then vertical searches based on the current location, as shown in FIG. 5. The complete processes of OTA algorithm are as follows:
(1) Conduct horizontal searches first, based on the original point located at the central point of the block to be searched.
(2) Locate the minimum difference point by reference to points to be searched. Terminate the horizontal search once the minimum difference point is the central point of the points to be searched, otherwise conduct another search based on the current minimum difference point until the minimum difference point is at the central point of our search.
(3) Terminate the horizontal search once the minimum difference point on horizontal direction is located. Conduct the vertical search until the minimum difference point, which is the central point of the search, is located, then terminate the algorithm.

Among all current algorithms, OTA is the one with least video processing requirement and highest performance, but it is still not perfect, which conducts only one horizontal, and vertical best point search in its operating process. If the searching direction is away from the expected point at the beginning, the searching result may cause image distortion, as shown in FIG. 6, in which the black spot is the expected point, the white spots are initial searching center, and the gray are the best values found on horizontal and/or vertical searches

Throughout the whole H.264 algorithm, Motion Estimation is the most calculation-intensive part, which has highlighted a very important issue about how to further improve the algorithm performance without sacrificing image quality.

### SUMMARY OF THE INVENTION

In view of the imperfections of conventional video codec method, the inventor of the present invention has spent years researching and developing innovative video codec technology and eventually came up with a video codec with high performance.

The major purpose of present invention is to provide a solution to the motion prediction algorithm for video encoding, which can reduce the overall amount of video encoding processing and improve calculation performance without sacrificing video quality.

Another purpose of this invention is to provide a video encoding method with high performance, in which we may improve the original OTA algorithm from the original sampling block by mapping it to other sampling blocks, and make a more accurate motion prediction on the sampling block to avoid the wrong prediction that an OTA algorithm might result in when the motion vector is exceedingly large.

Another purpose of this invention is to provide a video decoding method with high performance, in which good quality at remarkably low data rates in high performance is provided.

### DETAILED DESCRIPTION OF THE PREFERRED EMBODIMENT

FIG. 7 shows the flow chart of the motion prediction algorithm for video encoding of this invention. This invention is a video codec method with high performance, which enters into the Inter Mode 20 after it starts at 10, comprising the following steps:
(1) Median Prediction & Up-layer Prediction 30: Predict the motion vector in the block to be predicted via Median Prediction and Up-layer Prediction.
(2) Calculate SAD (Sum of Absolute Differences) via preset termination or early termination, 40: Once the predicted motion vector is lower than a threshold value, which can be set between 0 and 400 according to requirement, terminate the motion estimation in this block under prediction, 60, otherwise execute the enhanced OTA searching algorithm, 50.
(3) The enhanced OTA searching algorithm, 50: sample data in the block to be predicted and then, based on the data sampled; determine a block best resembling the above area from which samples for a further OTA search to finish a block motion prediction. By such steps, the overall amount of video encoding processing is dramatically reduced and performance is improved without sacrificing video quality. In addition, we may also improve the original OTA algorithm from the initiate sampling block by mapping it to other sampling blocks, and make a more accurate motion prediction of the block to be predicted to avoid the wrong prediction that an OTA algorithm might result in when the motion vector is exceedingly large.

The determination of the threshold value is crucial in the overall algorithm. We hold discussions on various testing images in order to determine an adequate threshold value to reach the best performance and best quality. As shown in Table 1, we may see the results caused by different threshold values for still videos (AKIYO, NEWS), and animated videos (FOREMAN, COASTGUARD), respectively. It is obvious that animated videos are more closely related to threshold value, mainly because the areas with still images dominate the animated image; therefore, most blocks are defined as early termination blocks, and consequently lower images quality (dB values) are seen. On the contrary, the interrelationship of an animated image is determined by the quantity of its own animated blocks. Accordingly, when we determine the threshold value, Median Early Termination SAD, as 250, still video AKIYO drops by 2.7 dB, NEWS 2.44 dB, FOREMAN 0.97 dB, and COASTGUARD 0.22 dB. The visual acuity of human eyes is less sensitive on seeing still images; therefore, the lower quality for still images is allowed in order to improve overall algorithm.

Table 1 & 2 are Median, Up-layer Early Termination, from which we know the dB value of Up-layer decays at a higher rate than that of Median. In order to maintain a better image quality, we define a lower threshold value of 200 for Up-layer Early Termination. Median Prediction and Up-layer Prediction can be different values in terms of determining threshold values.

In addition, In traditional OTA algorithm, if the searching direction is away from the expected point at the beginning, the searching result may cause image distortion, which has been mentioned in previous descriptions, no more unnecessary details here. In order to solve this problem, in this invention we conduct sampling first in the block to be searched with original OTA search algorithm framework, as shown in FIG. 8, in which the five points are the initial sampling points for each searching blocks. What follows is determining a block best resembling candidate points for an OTA search, based on the above-mentioned block, and enhancing the accuracy of OTA algorithm via initial sampling blocks. Consequently, we may remedy the deficiency of OTA algorithm. This is the enhanced OTA algorithm used in this invention. Reviewer may refer to FIG. 9, for further knowledge of enhanced OTA algorithm. FIG. 9 illustrates the flow chart of the enhanced OTA algorithm adopted in this invention, in which a sampling on blocks to be searched and locating of candidate blocks are done, 52. And then is the execution of OTA algorithm, 53. Finally, it is the end, 54.

Viewing from Table 3, we know very clearly that the video quality is greatly improved in the testing videos, NEWS, FOREMAN, and COASTGUARD. The major reason is that we can make more accurate motion prediction, through the comparisons among the sampling blocks, on the possible blocks to remedy the wrong prediction that an OTA algorithm might result in when the motion vector is exceedingly large. While we may see the worse video quality in the testing video, AKIYO, mainly because most of the testing scene is comprised of blocks with still background, in which the motion vector prediction made based on the candidate blocks may lead to wrong judgments, and then the worse results from the search an initial OTA algorithm is made based on initial central points.

Throughout the testing process, we will use JM97 H.264 Encode Baseline Profile as our reference of review standard. The performance and video quality (dB) of the testing videos AKIYO, NEWS, FOREMAN, and COASTGUARD are reviewed (300 frames) against the above-mentioned algorithms. The reviews are simulated in ARM Developer Suite environment, and the actual simulation frames are 201 to 230 (30 frames).

Table 4 shows the dB values of each testing video obtained from the testes by the aforementioned algorithms. Table 5 is the performance comparison table, in which the performance data are obtained by optimizing those from aforementioned algorithms. We may see an increase more than tenfold in performance over original JM.

For video decoding method, two major optimizations is applied: (i) one is called dynamically optimization, which implies that we focus on the video-algorithm optimization on those portions with the larger task profiles in a specific decode or encode, and (ii) the other is called statically optimization, which implies we develop a set of compiler techniques to enhance and fine-tune the performance.

We present different video-algorithm optimizations for different video codecs since the task profiles at the raw source codes, please see FIGS. 10, 11, and 12, of the source codes are different. For instance, in FIG. 10, shows the block diagram of H.264 Baseline Profile (BP) Decode. The components we would like to optimize are (i) Motion Compensation (MC), Intra Prediction, Inverse Transformation (IT), Inverse Quantization (IQ), Entropy decoding called CAVLD, and etc. In addition the task profiling for each portion in the codes is also shown above. The major portions are (i) Interpolation taking 29.97%, (ii) CAVLD taking 23.89%, and (iii) Deblocking taking 20.91%.

On the contrast, in FIG. 11, for the case of H.264 encode, the motion estimation takes around 67% which is huge portion compared to other profiles. Note that the profiles are changeable if you have incorporated some of optimization skills and the performance data have been improved. That is why we have to moving our eyes on different profiles to deal with different software improvement skills. We may call this video-algorithm optimization as dynamically optimization based on the percentage of the concurrent task profiling data.

FIG. 12 shows the case in VC-1 decode. The major portion for the source code is Inverse Transformation. It takes around 46% of the VC-1 decode.

In addition, we also present the same compiler techniques or program code optimization skills for those different codecs to enhance and fine-tune the final performance. The compiler techniques and program optimization skills include the loop unrolling, loop unswitching, loop interchange, loop fusing, etc. Those compilier techniques can help to improve the loop overhead, increase instruction parallelism, increase register locality, reduce miss rate, and reduce memory accesses. These techniques are used in generic for the codes even though these codes are named as different decode or decode or audio and video. No matter what these codes are featured as decode/encode or others. We would try a set of compiler techniques to enhance the performance. That is why we called this method as statically optimization.

We use H.264 encode and H.264 decode for the use cases. We would present these two comprehensive methodologies for them respectively. For H.264 decode, we use more compiler techniques in statically optimization. On the other hand, for H.264 encode, we use more heuristics in dynamically optimization for video algorithm optimization.

We have developed some video decode standard such as (i) H.264 decode, (ii) MPEG-4 decode, (iii) VC-1 decode, and (iv) AVS decode (Advanced Video System—for China).

The techniques we used in video decode are different from the techniques we used in video encode. The property of the video decode is that we may not have much room to do the video algorithm optimization since the algorithms have been fixed in most ports. Therefore, this results in why we used more techniques in statically optimization regarding to compiler techniques and programming optimization skills.

On the other hand, there exists more room for video algorithms optimization such as created heuristics in motion estimation to speed up the performance. That is why dynamically optimization can play mostly. Compared to statically optimization, dynamically optimization is more important for video encode. Statically optimization can be involved to fine-tune the video encode and video decode. Based on the reasons above for the video encode, statically optimization is more important for video decode.

A set of comprehensive methodology has been used for the code optimization in the case of H.264 decode. This methodology includes dynamically optimization and statically optimization as mentioned before.

The dynamically optimization includes the optimization in (i) 4×4 integer transform by using the loop unrolling techniques to reduce the numbers of operations, (ii) Interpolation by using loop unswitching to reduce the loop overhead, (iii) Macroblock position by using a look-up table to reduce the computation complexity and memory access numbers, (iv) Deblocking filter by using a method of vectorization to reduce the memory accesses, (v) Intra prediction by using a method of vectorization to reduce the computation complexity and memory accesses.

The codes in 4×4 integer transform have been reformed by using the technique of loop unrolling. Before the optimization, the codes need 16 adders, 8 shifters, and 32 memory loads. However, after the optimization by unrolling the codes, the number of operations has been reduced. This is because the operations of load, store, and arithmetic can be vectorized. The codes now only need 4 adders, 2 shifters and 4 memory loads. Please refer FIG. 13. FIG. 13 shows unrolling and reordering the codes to meet the vector forms in 4×4 integer transform.

There exists a condition of if-else inside this three-nested loop in the code of interpolation. The price is quite expensive if the condition exists in the loop. Here we use a technique of loop unswitching to resolve this problem to ensure the reduction of loop overhead. This helps much to increase the performance for the code. Please refer FIG. 14. FIG. 14 shows if-else condition inside a 3-nested loop.

Vectorization is proposed for the computation in interpolation. This method helps to reduce a lot of operations and reduce the memory accesses. Please refer FIG. 15. FIG. 15 shows vectorization.

The x-y address for each block has been converted to a number address based on the following look-up table. The reason we used a ONE-number of address instead of x-y number for each block is to save the computation steps and the number of loads. The complexity of computation and the number of memory access are reduced. Please refer FIG. 16. FIG. 16 shows a look-up table.

This is because a significant amount of division and modulo operations used in x-y macroblock coordinates has been reduced for a given macroblock address.

There exist four pixels in a specific block having the same strength in the code of deblocking filter. A vectorization method can be used to reduce the overhead in the memory access and computation steps. Please refer FIG. 17. FIG. 17 shows boundary strength.

In intra prediction code, DC , horizontal and vertical mode can also be vectorized. Please refer FIG. 18. FIG. 18 shows 4*4 luma prediction (vertical/horizontal) modes vectorization.

There is a huge performance enhancement by applying the above methods on these portions of H.264 decode. This includes that (i) 95% performance improvement in the term of “Marcoblock Position”, (ii) 80% performance improvement in the term of “Interpolation”, (iii) 75% performance improvement in the term of “4×4 Integer Transform”, (iv) 75% performance improvement in the term of “deblocking filter”, and (v) 20% performance improvement in the term of “Intra Prediction”.

There are a lot of compiler techniques and program optimization skills which has been incorporated in the entire code write-up. Those techniques include (i) loop unrolling which is used to enhance the instruction parallelism, reduce the loop overhead, increase the register locality, (iii) shifters which are used to reduce the overhead at the dividers and multipliers, (iv) local variable which is used to replace global variable; it is better to use local variable in the loop instead of global variable in the loop to improve the performance, (v) 1-D array which is used instead of 2-D array, (vi) inline method which is used to reduce the overhead for the call function; especially if the functions are called frequently.

Loop unrolling techniques are used for those codes with the known repeated times, and for those functions which are called frequently such as the codes in interpolation regarding to the portions related to luminance and chrominance. As known, the technique of loop unrolling is used to improve the code performance since it helps to reduce the loop overhead, increase instruction parallelism, and improve register, data cache or TLB (translation look-aside buffer) locality. Please refer FIG. 19. FIG. 19 shows loop unrolling.

In the code, we always use the shifter to replace the expensive divider and multiplier. For instance, the data is shifted right and the data is getting smaller by using the operation of division. The data is shifted left and the data is getting bigger by using the operation of multiplication. Please see below of the

| | | |
|---|---|---|
| Ex. | Temp/16 | Temp >> 4 (shift right) |
| Ex. | Temp * 8 | Temp << 3 (shift left) |

The local variable is frequently used in the loop instead of global variable to improve the performance. In addition, we use local variable to point a global variable and also use the local variable for the computation.

1-D array is frequently used instead of 2-D array to reduce the number of memory accesses.

The inline method is used for those functions which are called frequently such as the function in JM codes as function Like Showbits( ).

We simplify the C codes in H.264 Baseline Profile (BP) based on the following techniques we have used: (i) Refine coding style ( ex. ShowBits ), (ii) Partition the function of getNonAffNeighbor( ) into several functions, (iii) Reduce data type from short(16-bits) to char(8-bits) during the process of decoding, (iv) Refine Deblock( ), and (v) Refine get-block( ).

Our codes are written as simple as possible to reduce the code size overhead. In addition, the code can be used for H.264 Baseline Profile (BP) and H.264 Main Profile (MP).

We gradually re-write the code based on some of optimization skills and make the call function efficient.

A function is split since some portions of the function is called frequently but some portions of that function is seldom to be called. We then split the function into separate called functions to reduce the overhead of computation complexity.

We use char (8-bit) data type during the process of decoding to enhance the performance.

We also use some optimization schemes in algorithmic level: (i) reduce the operations based on the property of the coefficient symmetry, (ii) reduce the computation steps based on a table construction for the frames, (iii) if the block is full of zero data, this block is not necessary to be processed such as transform and construction, and (iv) if we know the numbers in a stripe in a block are the same; for the case of A^{st} pixel is not processed, the other three pixels are ignored. This helps to reduce more in computation steps.

For the case in luminance interpolation, the coefficients are {1 −5 20 20 −5 1} from the equation of the follows.

a+b*−5+c*20+d*20+e*−5+f

We could simplify the expression as below. This is because we find that there are same coefficients in the expression.

a+f−((b+e)−((c+d)<<2))*5

The original expression has five adders, and four multipliers. However, after simply change the expression by using the shifters instead of multipliers and dividers, we only use five adders, one shifter, and one multiplier.

In many case in the codes, we know that the computation would be the same for each frame. We could compute the case and make a unified table which can be used for other frames without the overhead in the repeated computation.

If we know that the block is filled with all zero data, the block can be ignored and the transform and reconstruction are not necessary to be done for this special case.

We know that in the deblocking codes, the strength data of a 4-pixel in one stripe is the same. So if the 1^{st} pixel is not necessary to be done for the deblocking, the other three pixels are ignored to reduce the computation steps.

Table 6 show the performance for video decode has been done using 300 frames for the test. The performance data are obtained by optimizing those from aforementioned algorithms. We may see an increase more than tenfold in performance over original JM.

As is understood by a person skilled in the art, the foregoing preferred embodiment of the present invention is an illustration, rather than a limiting description, of the present invention. It is intended to cover various modifications and similar arrangements, for example, the threshold value all the above may vary and should be considered within the spirit and scope of the appended claims of the present invention. In short, the spirit and scope should be accorded the broadest interpretation so as to encompass all such modifications and similar structures.

### BRIEF DESCRIPTION OF THE DRAWINGS

FIG. 1 is a diagram showing the illustration of Median Prediction reference block.

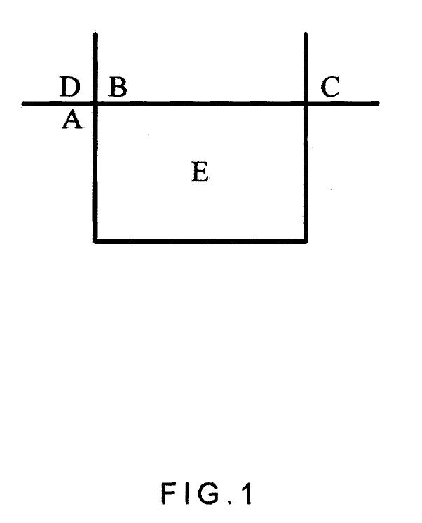

FIG. 2 is a diagram showing the illustration of Median Prediction motion vector.

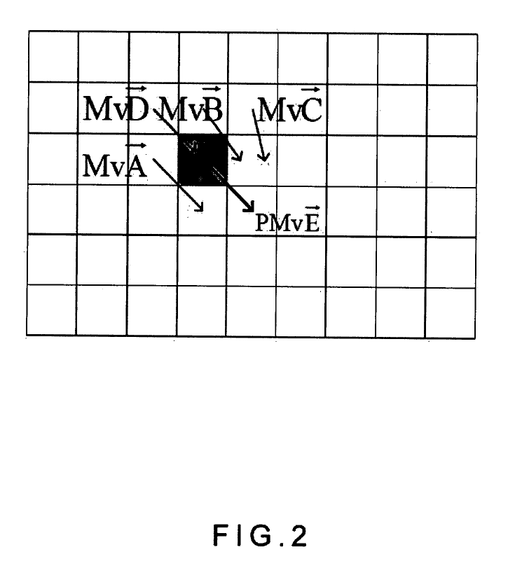

FIG. 3 is a diagram showing the illustration of seven types of Block Motion Searches.

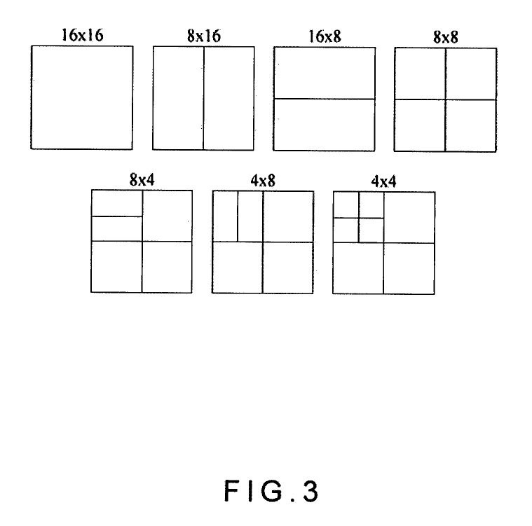

FIG. 4 is a diagram showing the illustration of Up-layer motion vector.

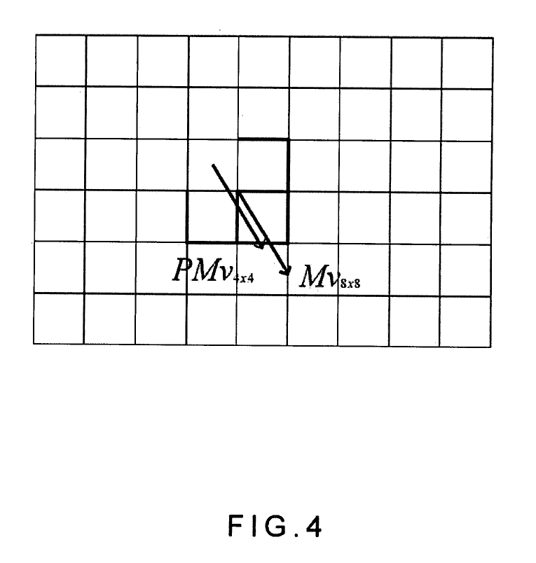

FIG. 5 is a diagram showing the illustration of OTA algorithm.

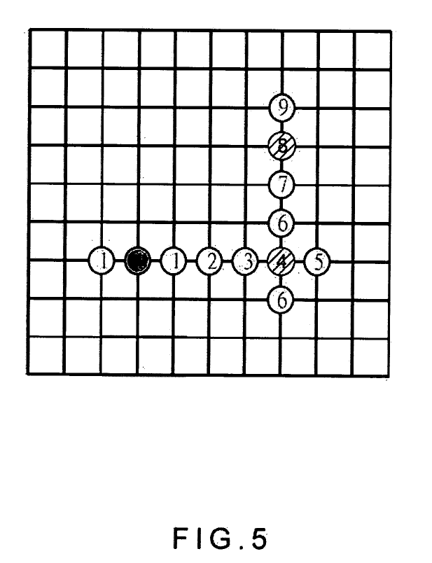

FIG. 6 is a diagram showing the illustration of OTA algorithm with the searching direction is away from the expected point.

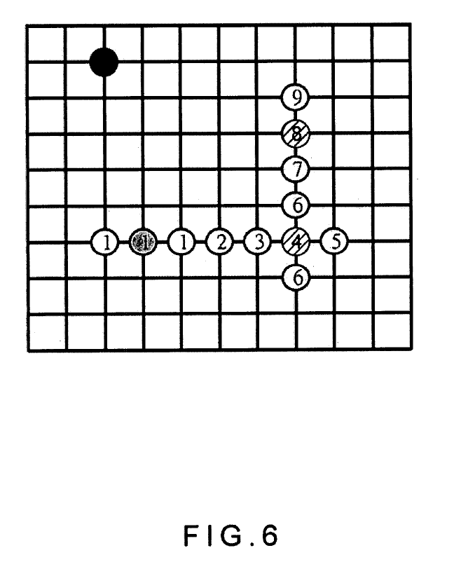

FIG. 7 is a diagram showing the flow chart of the motion prediction algorithm for video encoding of this invention.

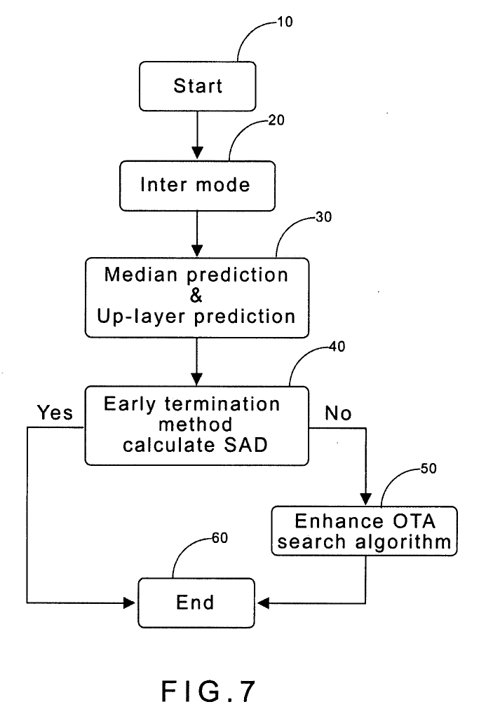

FIG. 8 is a diagram showing the illustration of the sampling data of enhanced OTA algorithm of this invention.

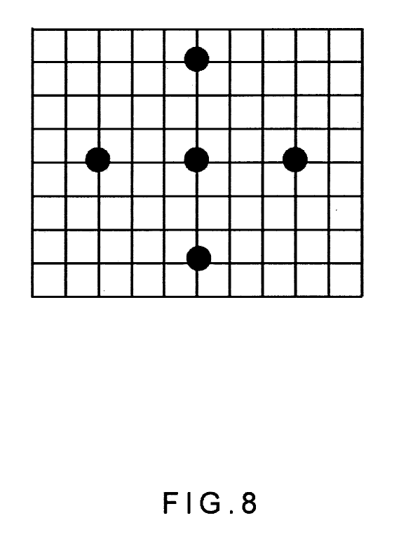

FIG. 9 is a diagram showing the flow chart of enhanced OTA algorithm of this invention.

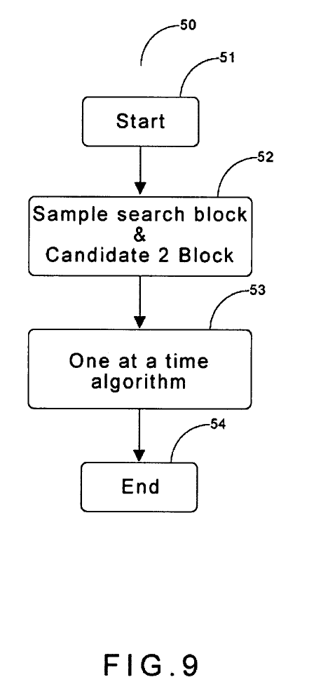

FIG. 10 is a diagram showing the block diagram of H.264 Baseline Profile (BP) Decode

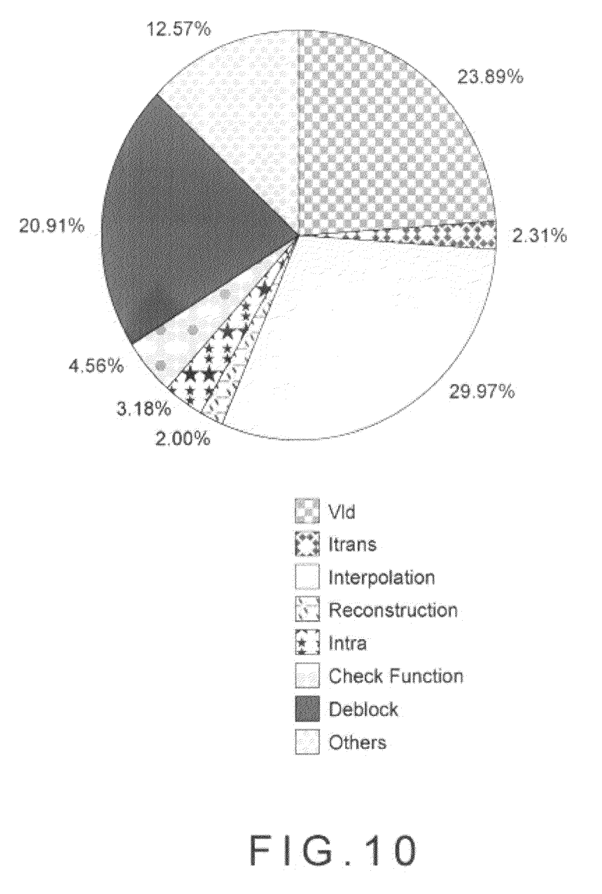

FIG. 11 is a diagram showing the task profiling on H.264 encode

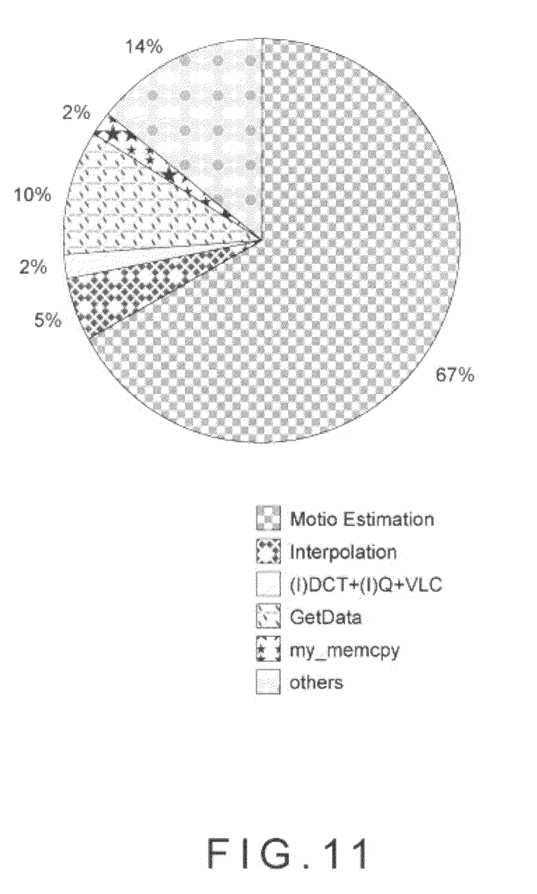

FIG. 12 is a diagram showing the task profiling on VC-1 decode

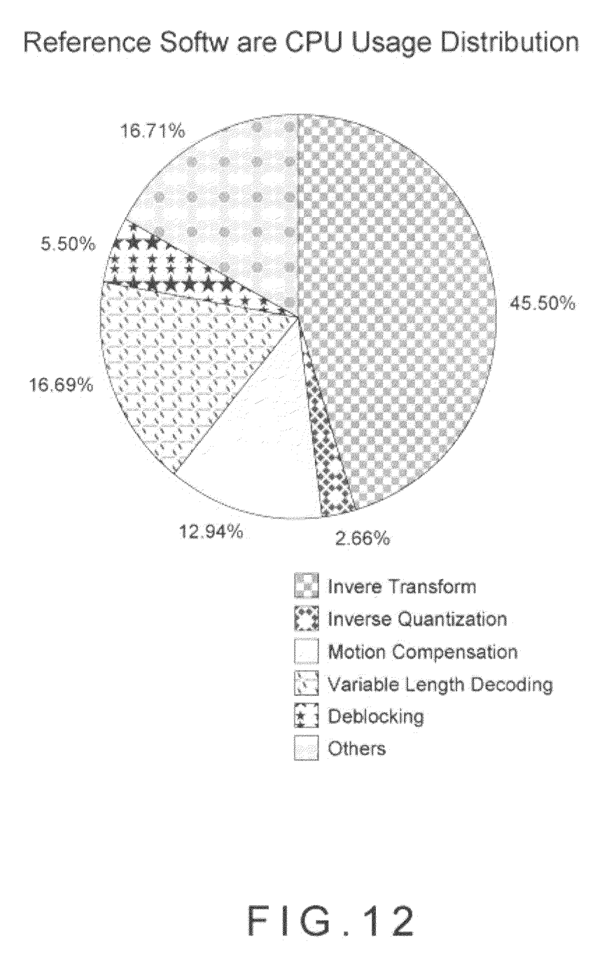

FIG. 13 is a diagram showing unrolling and reordering the codes to meet the vector forms in 4×4 integer transform.

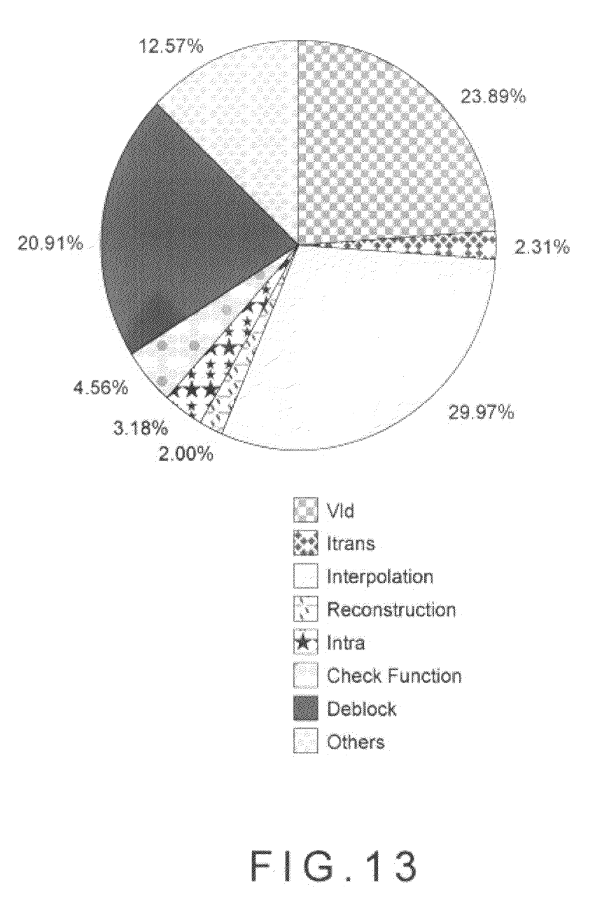

FIG. 14 is a diagram showing if-else condition inside a 3-nested loop.

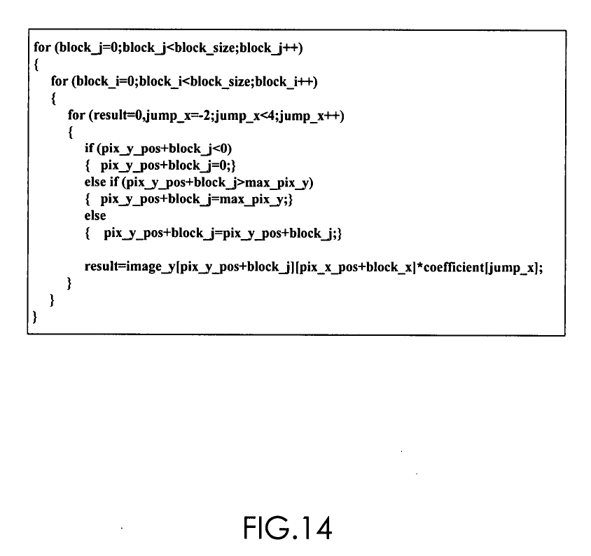

FIG. 15 is a diagram showing vectorization.

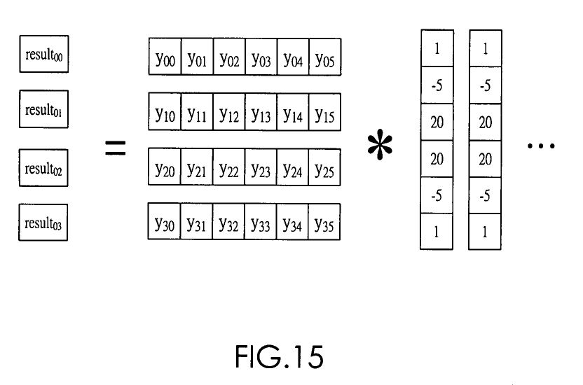

FIG. 16 is a diagram showing a look-up table.

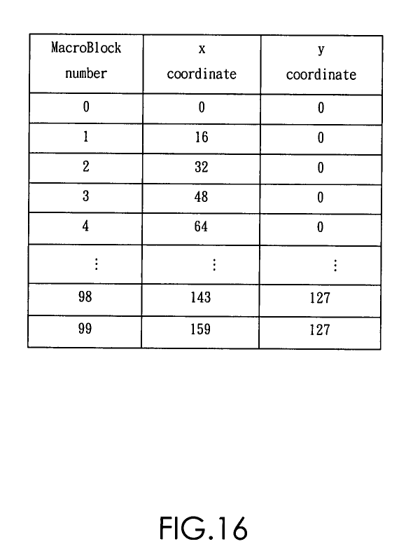

FIG. 17 is a diagram showing boundary strength.

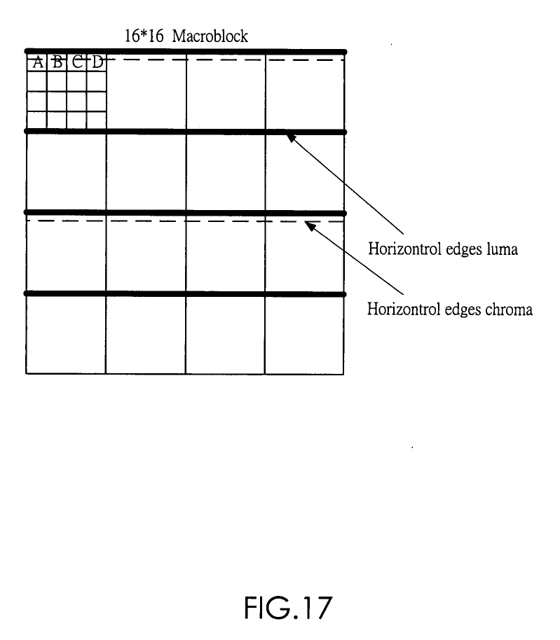

FIG. 18 is a diagram showing 4*4 luma prediction (vertical/horizontal) modes vectorization.

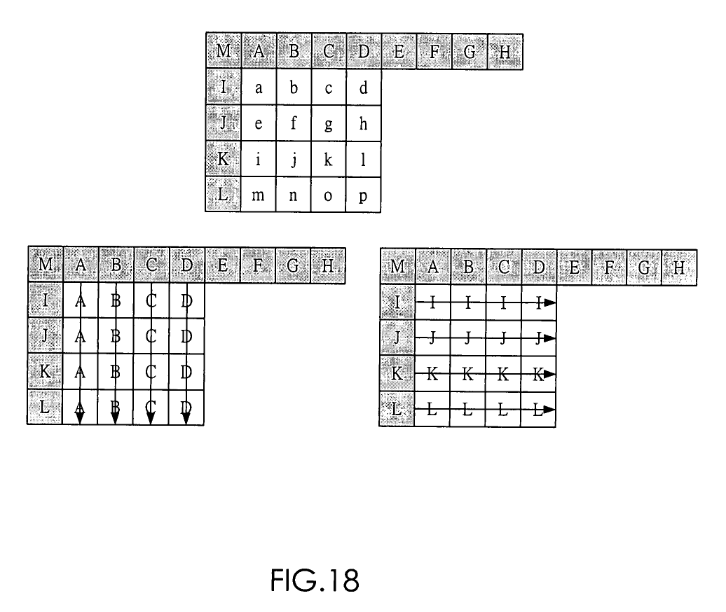

FIG. 19 is a diagram showing loop unrolling.

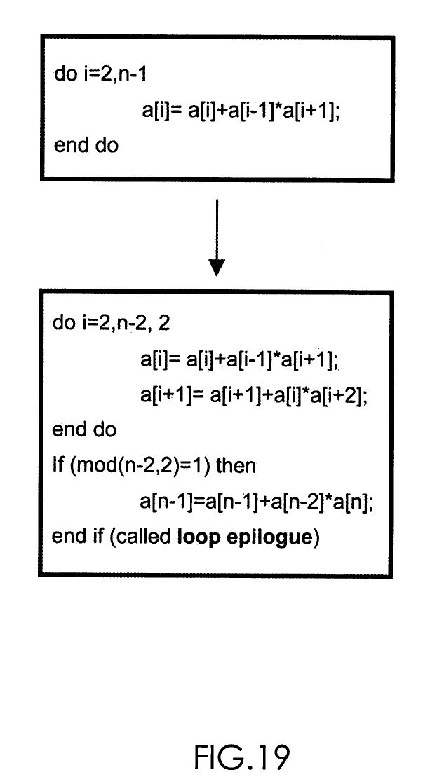

TABLE 1 shows the results caused by different threshold value of Median Early Termination for testing videos.
TABLE 2 shows the results caused by different threshold value of Up-layer Early Termination for testing videos.
TABLE 3 shows the video quality of each testing video obtained from the testes by the aforementioned algorithms.
TABLE 4 shows the dB values of each testing video obtained from the testes by the aforementioned algorithms.
TABLE 5 shows the performance data obtained by optimizing those from aforementioned algorithms (encoder).
TABLE 6 shows the shows the performance data obtained by optimizing those from aforementioned algorithms (decoder).

TABLE 1

| Median early | | | | | | | | |
|---|---|---|---|---|---|---|---|---|
| termination | AKIYO | ΔdB | NEWS | ΔdB | FOREMAN | ΔdB | COASTGUARD | ΔdB |
| TH0 | 42.8 | 0.00 | 37.12 | 0.00 | 33.88 | 0.00 | 31.13 | 0.00 |
| TH50 | 42.25 | 0.55 | 37.01 | 0.11 | 33.87 | 0.01 | 31.13 | 0.00 |
| TH100 | 40.87 | 1.93 | 36.23 | 0.89 | 33.81 | 0.07 | 31.13 | 0.00 |
| TH150 | 40.39 | 2.41 | 35.43 | 1.69 | 33.6 | 0.28 | 31.13 | 0.00 |
| TH200 | 40.12 | 2.68 | 34.99 | 2.13 | 33.28 | 0.60 | 31.11 | 0.02 |
| TH250 | 39.91 | 2.89 | 34.6 | 2.52 | 32.88 | 1.00 | 30.94 | 0.19 |
| TH300 | 39.61 | 3.19 | 34.39 | 2.73 | 32.49 | 1.39 | 30.74 | 0.39 |
| TH350 | 39.32 | 3.48 | 34.17 | 2.95 | 32.12 | 1.76 | 30.5 | 0.63 |
| TH400 | 39.06 | 3.74 | 33.93 | 3.19 | 31.76 | 2.12 | 30.27 | 0.86 |

TABLE 2

| Up-layer early | | | | | | | | |
|---|---|---|---|---|---|---|---|---|
| termination | AKIYO | ΔdB | NEWS | ΔdB | FOREMAN | ΔdB | COASTGUARD | ΔdB |
| TH0 | 42.8 | 0.00 | 37.12 | 0.00 | 33.88 | 0.00 | 31.13 | 0.00 |
| TH50 | 42.21 | 0.59 | 37 | 0.12 | 33.86 | 0.02 | 31.13 | 0.00 |
| TH100 | 40.82 | 1.98 | 36.26 | 0.86 | 33.82 | 0.06 | 31.13 | 0.00 |
| TH150 | 40.39 | 2.41 | 35.47 | 1.65 | 33.65 | 0.23 | 31.13 | 0.00 |
| TH200 | 40.05 | 2.75 | 35.01 | 2.11 | 33.32 | 0.56 | 31.11 | 0.02 |
| TH250 | 39.49 | 3.31 | 34.63 | 2.49 | 32.95 | 0.93 | 30.96 | 0.17 |
| TH300 | 39 | 3.80 | 34.32 | 2.80 | 32.5 | 1.38 | 30.74 | 0.39 |
| TH350 | 38.58 | 4.22 | 33.97 | 3.15 | 32.06 | 1.82 | 30.45 | 0.68 |
| TH400 | 38.16 | 4.64 | 33.64 | 3.48 | 31.61 | 2.27 | 30.17 | 0.96 |

TABLE 3

| | sequence | | | |
|---|---|---|---|---|
| Algorithm | AKIYO | NEWS | FOREMAN | COASTGUARD |
| OTA | 42.85 | 36.59 | 31.69 | 30.53 |
| Enhance OTA | 42.77 | 37.1 | 33.67 | 31.11 |
| Difference | −0.08 | +0.51 | +1.98 | +0.58 |

TABLE 4

| | AKIYO | NEWS | FOREMAN | COASTGUARD |
|---|---|---|---|---|
| JM | 42.96(dB) | 37.15 | 33.96 | 31.13 |
| Propose | 42.82 | 36.55 | 32.66 | 30.82 |
| Difference | −0.14 | −0.6 | −1.3 | −0.31 |

TABLE 5

| | AKIYO | NEWS | FOREMAN | COASTGUARD |
|---|---|---|---|---|
| JM | 13575568225 | 13427045363 | 13795394127 | 13494434555 |
| Propose | 963210556 | 947755785 | 1098760146 | 1015433079 |
| Rate | 14.1 | 14.2 | 12.6 | 13.29 |

TABLE 6

| | |
|---|---|
| CIF | QCIF |

| | Before | After | Before | After |
|---|---|---|---|---|
| | optimi- | optimi- | optimi- | optimi- |
| H.264 BP | zation | zation | zation | zation |
| Decode@60 MHz | 0.28 fps | 3.5 fps | 1.85 fps | 16 fps |

What is claimed is:

1. A high performance video encoding method with comprising:
(i) Predicting the motion vectors in the blocks to be predicted through Median Prediction and Up-layer Prediction;
(ii) Terminating the motion prediction in the blocks predicted once the predicted motion vectors are below a threshold value, otherwise;
(iii) Sampling data in the block to be predicted and then, based on the data sampled, determine a block best resembling the above block from which samples are sampled for a further OTA search to finish a block motion prediction;
and wherein, with above said design and structure, the overall amount of video encoding processing is dramatically reduced and performance is improved without sacrificing video quality.

2. The high performance video encoding method as in claim 1, wherein the threshold value of said Median Prediction and said Up-layer Prediction could not be the same.

3. The high performance video encoding method as in claim 1, wherein the threshold value of said Median Prediction could be 250.

4. The high performance video encoding method as in claim 1, wherein the threshold value of said Median Prediction could be 200.

5. A high performance video decoding method with comprising:
(i) 4×4 integer transform, using the loop unrolling techniques to reduce the numbers of operations;
(ii) Interpolation, using loop unswitching to reduce the loop overhead;
(iii) Macroblock position, using a look-up table to save one-number of address instead of x-y number represented computation steps and the number of loads, to reduce the computation complexity and memory access numbers;
(iv) Deblocking filter, using a method of vectorization to reduce the memory accesses; and
(v) Intra prediction, using a method of vectorization to reduce the computation complexity and memory accesses;
and wherein, with above said design and structure, good quality at remarkably low data rates in high performance is provided.

6. A high performance video decoding method with comprising:
(i) Loop unrolling, used to enhance the instruction parallelism, reduce the loop overhead, and increase the register locality;
(ii) Shifters, used to reduce the overhead at the dividers and multipliers;
(iii) Local variable, used to replace global variable for improving the performance;
(iv) 1-D array, used instead of 2-D array; and
(v) Inline method, used to reduce the overhead for the call function;
and wherein, with above said design and structure, good quality at remarkably low data rates in high performance is provided.

7. A high performance video decoding method with comprising:
(i) Reducing the operations based on the property of the coefficient symmetry;
(ii) Reducing the computation steps based on a table construction for the frames;
(iii) If the block is full of zero data, this block is not necessary to be processed such as transform and construction; and
(iv) If the numbers in a stripe in a block are the same, the computation steps can be more reduced;
and wherein, with above said design and structure, good quality at remarkably low data rates in high performance is provided.
